(19) United States
(12) Patent Application Publication
(10) Pub. No.: US 2008/0192720 A1
(43) Pub. Date: Aug. 14, 2008

(54) Shared control channel data-assisted channel estimation

(75) Inventors: Frank Frederiksen, Klarup (DK); Preben E. Mogensen, Gistrup (DK); Anders Ostergaard Nielsen, Frederiksberg (DK); Pedro Hojen-Sorensen, Allerod (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 12/069,896

(22) Filed: Feb. 12, 2008

Related U.S. Application Data
(60) Provisional application No. 60/901,620, filed on Feb. 12, 2007.

(51) Int. Cl. H04B 7/208

(52) U.S. Cl. 370/344

(57) ABSTRACT

An apparatus includes a channel estimator configurable to apply a first channel estimation algorithm to a resource mapping using known reference resources to obtain initial channel estimates; a decoder configurable to decode, based on the obtained initial channel estimates, a plurality of control channels to determine which of the plurality of decoded control channels comprise at least one preferred control channel; and an encoder configurable to re-encode the at least one preferred control channel to obtain at least one new reference resource. The channel estimator is further configurable to apply a second channel estimation algorithm to the resource mapping using the known reference resources and the at least one new reference resource to obtain revised channel estimates.

### PRIORITY CLAIM

This patent application claims priority under 35 U.S.C. §119(e) from U.S. Provisional Patent Application No. 60/901,620, filed Feb. 12, 2007, the disclosure of which is incorporated by reference herein in its entirety.

### TECHNICAL FIELD

The exemplary embodiments of this invention relate generally to wireless communication systems and, more specifically, relate to channel estimation in a wireless communication system having a shared control channel.

### BACKGROUND

The following abbreviations are utilized herein and are defined as follows:

| | |
|---|---|
| 3GPP | third generation partnership project |
| BER | bit error rate |
| CRC | cyclic redundancy check |
| C-RNTI | cell radio network temporary identifier |
| DL | downlink (Node B to UE) |
| DRX | discontinuous reception |
| FDD | frequency division duplex |
| HARQ | hybrid automatic repeat-request |
| LMMSE | linear minimum mean-square error |
| LTE | long term evolution of UTRAN |
| MAC | medium access control (layer 2, L2) |
| MCS | modulation and coding scheme |
| MIMO | multiple input/multiple output |
| Node B | base station |
| OFDM | orthogonal frequency division multiplexing |
| PedB | pedestrian B channel profile model |
| QAM | quadrature amplitude modulation |
| TBS | transport block size |
| TDD | time division duplex |
| TTI | transmission time interval |
| UE | user equipment, such as a mobile station or mobile terminal |
| UEID | user equipment identification |
| UMTS | universal mobile telecommunications system |
| UTRAN | UMTS terrestrial radio access network |

In RAN1#47, a working assumption for the DL control signaling, as relating to a LTE system, was made. The following compromise solution was endorsed. DL control signaling is located in the first n OFDM symbols, where n<3. Data transmission in the DL can, at the earliest, start in the same OFDM symbol in which the control signaling ends. Multiple control channels are used with each control channel being convolutionally coded. A UE monitors a number of control channels. One control channel carries information for one MAC ID. At least two formats (i.e., two MCSs) for control signaling are supported. The power setting of each control channel is up to the Node B.

### SUMMARY

In accordance with an aspect of the exemplary embodiments of this invention there is provided a method that includes applying a first channel estimation algorithm to a resource mapping using known reference resources to obtain initial channel estimates; decoding, based on the obtained initial channel estimates, a plurality of control channels to determine which of the plurality of decoded control channels comprise at least one preferred control channel; re-encoding the at least one preferred control channel to obtain at least one new reference resource; and applying a second channel estimation algorithm to the resource mapping using the known reference resources and the at least one new reference resource to obtain revised channel estimates.

In accordance with another aspect of the exemplary embodiments of this invention there is provided a computer-readable medium that stores computer program instructions. The execution of the computer program instructions results in operations that comprise applying a first channel estimation algorithm to a resource mapping using known reference resources to obtain initial channel estimates; decoding, based on the obtained initial channel estimates, a plurality of control channels to determine which of the plurality of decoded control channels comprise at least one preferred control channel; re-encoding the at least one preferred control channel to obtain at least one new reference resource; and applying a second channel estimation algorithm to the resource mapping using the known reference resources and the at least one new reference resource to obtain revised channel estimates.

In accordance with a further aspect of the exemplary embodiments of this invention there is provided an apparatus that includes a channel estimator configurable to apply a first channel estimation algorithm to a resource mapping using known reference resources to obtain initial channel estimates; a decoder configurable to decode, based on the obtained initial channel estimates, a plurality of control channels to determine which of the plurality of decoded control channels comprise at least one preferred control channel; and an encoder configurable to re-encode the at least one preferred control channel to obtain at least one new reference resource. The channel estimator is further configurable to apply a second channel estimation algorithm to the resource mapping using the known reference resources and the at least one new reference resource to obtain revised channel estimates.

In accordance with a further aspect of the exemplary embodiments of this invention there is provided an apparatus that includes means for applying a first channel estimation algorithm to a resource mapping using known reference resources to obtain initial channel estimates; means for decoding, based on the obtained initial channel estimates, a plurality of shared control channels to determine which of the plurality of decoded shared control channels comprise at least one preferred control channel; and means for re-encoding the at least one preferred control channel to obtain at least one new reference resource. The means for applying also applies a second channel estimation algorithm to the resource mapping using the known reference resources and the at least one new reference resource to obtain revised channel estimates.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows a simplified block diagram of various exemplary electronic devices that are suitable for use in practicing the exemplary embodiments of this invention;

FIG. 2 depicts a conventional mapping of DL reference signals (generic frame structure, normal cyclic prefix) from 3GPP TS 36.211, v0.1.2;

FIG. 3 illustrates an exemplary control channel and reference symbol structure in accordance with aspects of the exemplary embodiments of the invention;

FIG. 4 shows the loss due to channel estimation in a highly frequency selective channel (PedB);

FIG. 5 illustrates another exemplary control channel and reference symbol structure in accordance with aspects of the exemplary embodiments of the invention;

FIG. 6 depicts a flowchart illustrating one non-limiting example of a method for practicing the exemplary embodiments of this invention; and

FIG. 7 is a simplified block diagram of an exemplary apparatus suitable for implementing the exemplary embodiments of this invention.

### DETAILED DESCRIPTION

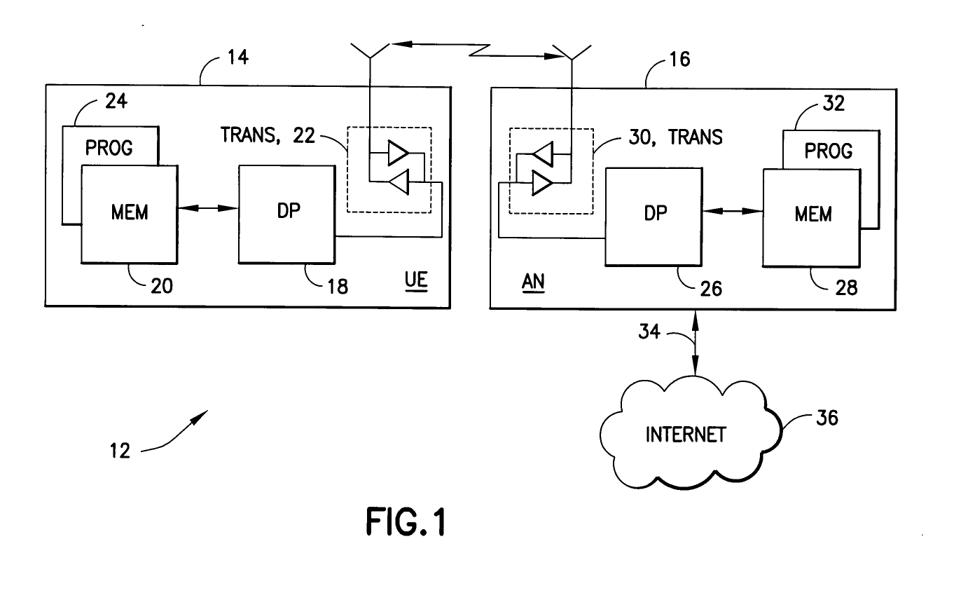

Reference is made to FIG. 1 for illustrating a simplified block diagram of various exemplary electronic devices that are suitable for use in practicing the exemplary embodiments of this invention. In FIG. 1, a wireless network 12 is adapted for communication with an n apparatus, also referred to herein as user equipment (UE) 14, via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of the invention relate at least in part to the encoding structure of the control channel, and how the encoding structure can be applied during a channel estimation process to improve the quality of the channel estimates and thereby the detection reliability of a shared data channel.

One of the challenges when designing a generic reference symbol layout (e.g., pilot structure) is that it is desirable to have as few reference symbols as possible while still maintaining good detection performance on the data and control channels. For LTE, the structure has been designed such that the reference symbols (at least for the primary and secondary antennas) take up around 5% of the available transmission symbols within a TTI for each transmit antenna (within a 0.5 ms slot, there will be around 200 reference symbols per transmit antenna and a total of 7*600 symbols available). This is towards the lower end of what is desirable (e.g., less than 10% overhead) when considering highly frequency selective channels (e.g., the PedB channel).

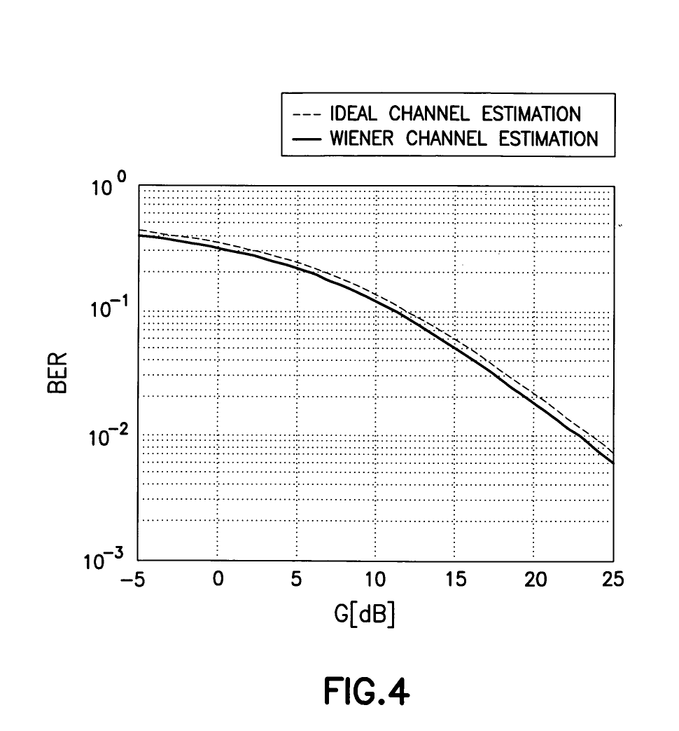

FIG. 4 illustrates the performance degradation (in terms of uncoded BER for 16-QAM) that may be observed for the PedB channel in the case where the pilot spacing is 6 sub-carriers (sub-carrier spacing is 15 kHz). The channel estimator used in this simulation is the optimal (in the LMMSE sense) linear channel estimator (i.e., the Wiener filter). If limited to only linear channel estimation, one cannot achieve better results than those shown in FIG. 4. In order to improve the channel estimation quality, one could utilize a non-linear channel estimator, such as the data-assisted approach further described below with respect to the exemplary embodiments of the invention.

The exemplary embodiments of the invention utilize a channel estimation algorithm implemented in such a way that it utilizes as much information as possible from the available control channels (both the reference symbols, and the shared control channel symbols—provided that the latter have a quality and implementation that allow such usage for improving the channel estimate). As non-limiting examples, ways of obtaining the quality estimate of the shared control channel include using a CRC that is appended to each shared control channel and/or using path metrics in a Viterbi algorithm (e.g., where the control channels are convolutionally coded).

In one non-limiting, exemplary embodiment, a multi-step channel estimation is used. The multi-step channel estimation has knowledge of the positioning in the time/frequency symbol grid for each shared control channel (where each of the shared control channels may be distributed within the first 3 OFDM symbols in a TTI, and also distributed over the sub-carriers within the system bandwidth). Further, this exemplary embodiment of the invention assumes that there exists a mechanism to verify the correct detection of each control channel (e.g., a kind of CRC, which the control channel would likely need regardless).

As a non-limiting example, an exemplary algorithm for performing the channel estimation comprises: Apply a channel estimation algorithm using only the known reference symbols (e.g., pilot symbols) for each antenna to obtain channel estimates. If necessary, perform MIMO processing on the control channels (i.e., combine the signals from each receive antenna using weights according to the MIMO setup) to obtain a composite signal. Decode the control channels and/or the composite signal to determine “preferred channels” and “non-preferred channels.” As non-limiting examples, the decoding may be performed using the CRC and/or other quality/reliability estimation algorithms. Re-encode the preferred control channels to obtain a new set of reference symbols. Perform another (i.e., new) channel estimation using both the known reference symbols as well as the new reference symbols (i.e., the control channel-based symbols obtained by the re-encoding). In other embodiments, this may be performed with a verification of the “quality” of the new reference symbols, such that if the new channel estimates differ too much from the known reference symbols, the new reference symbols are discarded.

In other embodiments, the algorithm may be repeated from performing MIMO processing (if necessary) to see if more control channels can be decoded correctly using the new improved channel estimate. In other embodiments, the algorithm is repeated only once more. In further embodiments, the algorithm is automatically repeated once more. In other embodiments, repeating may be performed in response to a condition not being met. In further embodiments, repeating may be performed, and the process iterated, until all of the control channels have been detected correctly (e.g., the CRC for each control channel is good). In further embodiments, repeating is performed in response to a condition being met or if necessary.

The exemplary algorithm may be particularly useful for cases where prior knowledge of the channel conditions has been lost, such as where the UE has just woken up from micro-sleep or DRX, as non-limiting examples. For such cases, it is especially important to have a high-quality channel estimate because it is not possible to use time-domain averaging to improve the reliability of the channel estimate.

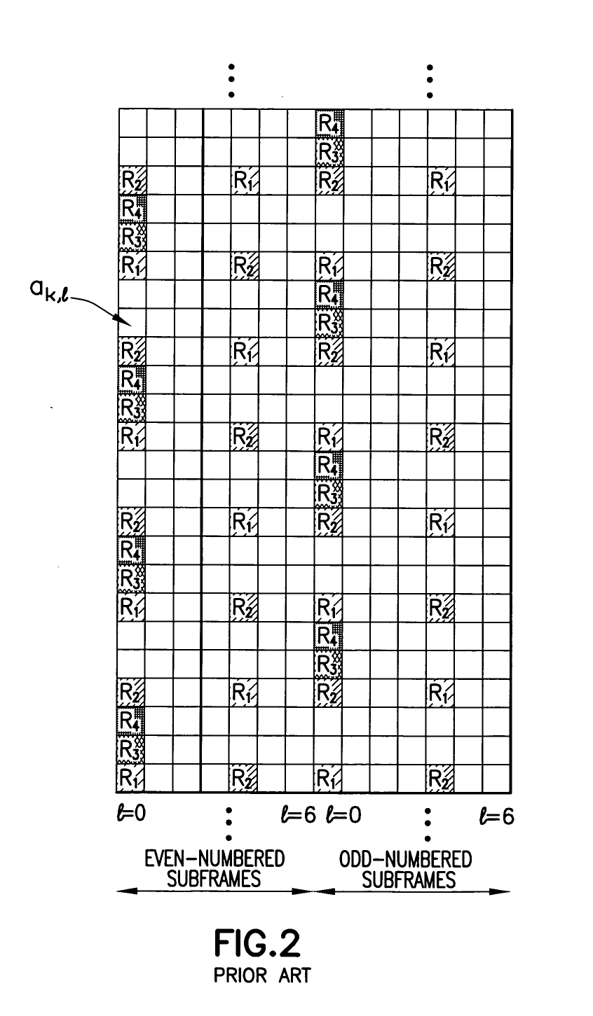

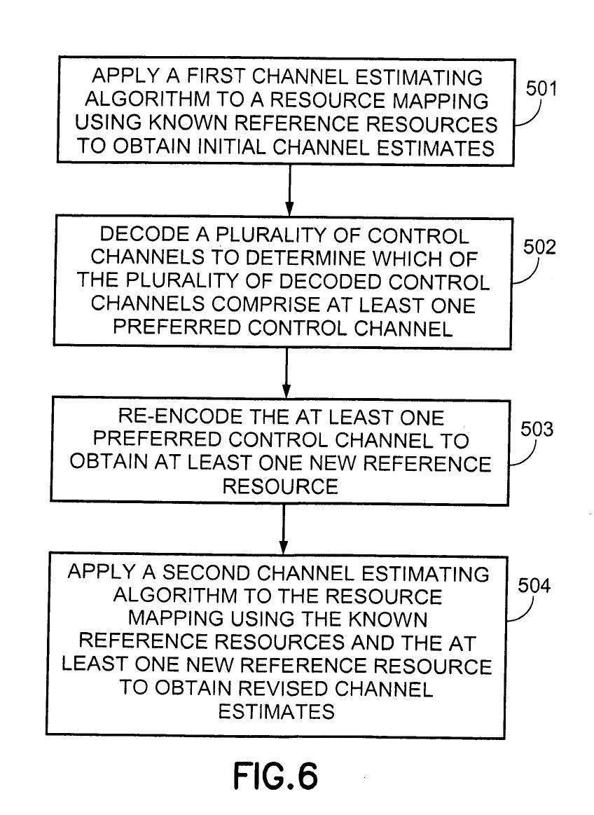

FIG. 2 depicts a conventional mapping of DL reference signals (generic frame structure, normal cyclic prefix) from FIG. 6 of 3GPP TS 36.211, “3rd Generation Partnership Project; Technical Specification Group Radio Access Network; Physical Channels and Modulation (Release 8),” v0.1.2, November 2006. 3GPP TS 36.211 v0.1.2 is incorporated by reference herein in its entirety. As noted in TS 36.211 v0.1.2, Rₖ indicates a resource allocated for a reference signal transmitted from the k-th antenna, where k=1, 2, 3 or 4. Note that in accordance with TS 36.211, one, two or four antennas may be utilized. Furthermore, and in accordance therewith, MIMO may or may not be used.

Although the exemplary embodiments of the invention are described below with respect to k=4 antennas and respective reference signals, the exemplary embodiments may be utilized in a system having a different number of antennas and/or a different number of reference signals.

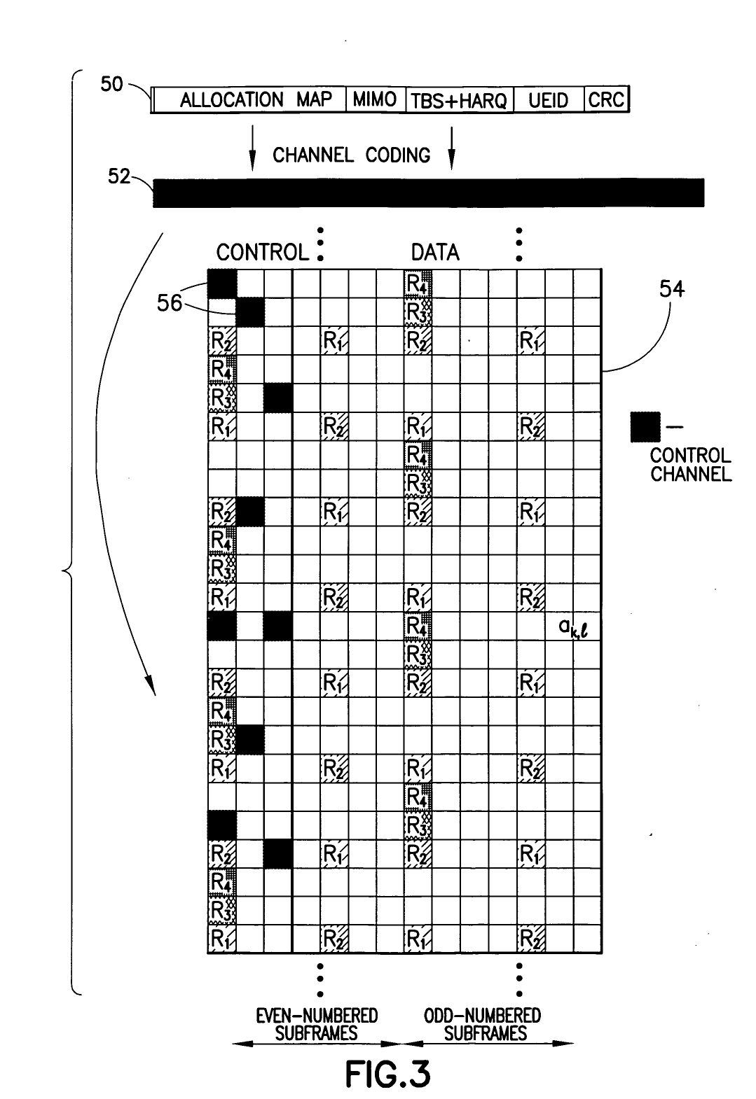

FIG. 3 illustrates an exemplary control channel and reference symbol structure in accordance with aspects of the exemplary embodiments of the invention. Information 50 is used to encode a resource allocation 52. The resource allocation 52 is used to allocate resources of the symbol structure 54, including resources for the common control channel (shown as solid blocks). Note that as in FIG. 2, reference signals for up to k=4 antennas are shown. Also note that the common control channel allocations are limited to the first three OFDM symbols. In other embodiments, the common control channel allocations may not be limited to a certain number of OFDM symbols (e.g., the first three OFDM symbols).

As a non-limiting example, consider an application of the above-described exemplary algorithm to the exemplary symbol structure 54 shown in FIG. 3. Assume there are no MIMO transmissions. Furthermore, assume that k=2 (i.e., only two antennas are present).

First, a channel estimation algorithm is applied using the known reference symbols (i.e., R₁ and R₂ reference symbols) to obtain initial channel estimates. Second, using the initially obtained channel estimates, the control channels are decoded to determine which are preferred (e.g., good quality) control channels. For this example, assume that two control channels 56 are identified as preferred control channels. Third, the two control channels 56 are re-encoded to obtain a new set of reference symbols. Fourth, another (new) channel estimation is performed using both the known reference symbols and the new reference symbols to obtain revised channel estimates, potentially including a power scaling of the new reference symbols to match the measured received power in the different control channels. Fifth, in response to a condition being met, the process (i.e., method) is repeated (e.g., from decoding the control channels) to see if more control channels can be decoded correctly using the revised channel estimates.

Note that although the working assumption is described above for the DL control signaling, as resulting from RAN1#47, the exemplary embodiments of the invention are not limited to the specified attributes. As a non-limiting example, the DL control signaling may be located in any number of first OFDM symbols (e.g., n>3). As another non-limiting example, instead of being convolutionally coded, different coding may be used for the channels, such as turbo coding or block coding, as non-limiting examples. As can be seen, the exemplary embodiments of the invention improve the quality of the channel estimates and the detection reliability of the shared data channel. Although the exemplary embodiments may result in the use of unique error detection for each allocation portion, such detection is likely to be necessary regardless due to the separate coding structure of the control channels. In other embodiments, the exemplary embodiments of the invention exploit the fact that the required CRC length is larger than the C-RNTI or UEID.

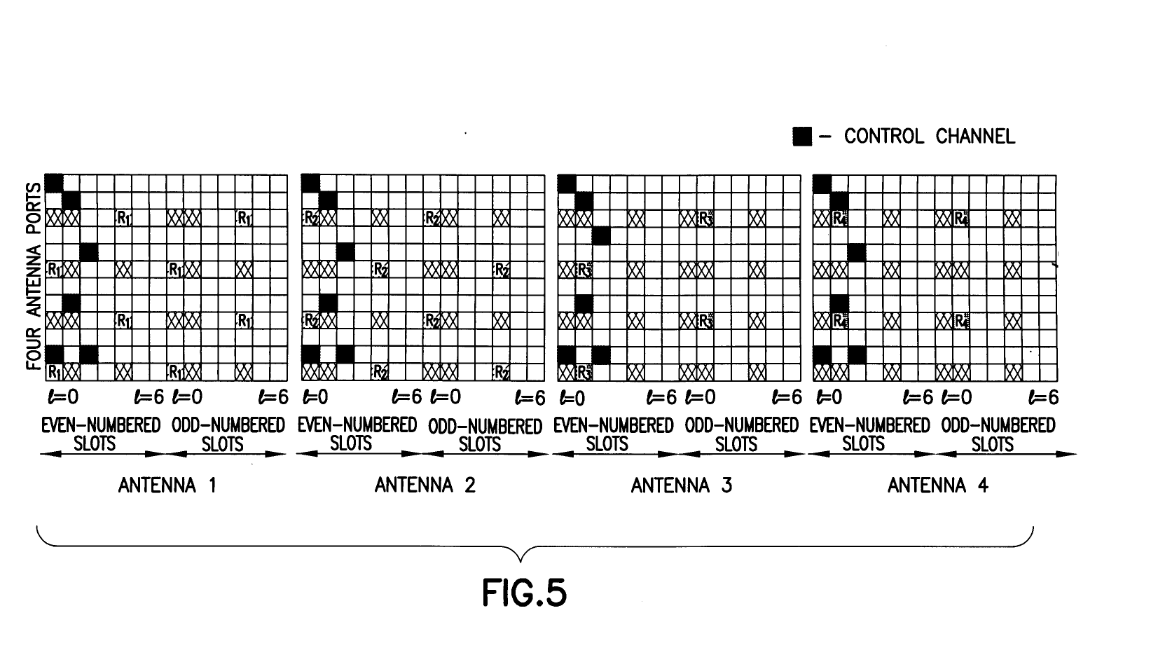

Note that the mappings depicted in FIGS. 2 and 3 are non-limiting examples for implementing the exemplary embodiments of the invention. That is, the exemplary embodiments of the invention may be implemented in conjunction with different mappings and structures. FIG. 5 illustrates another exemplary control channel and reference symbol structure in accordance with aspects of the exemplary embodiments of the invention. Note that the structure depicted in FIG. 5 is based on FIGS. 6.10.1.2-1 and 6.10.1.2-2 of 3GPP TS 36.211, “3rd Generation Partnership Project; Technical Specification Group Radio Access Network; Physical Channels and Modulation (Release 8),” v8.1.0, November 2007.

In one non-limiting, exemplary embodiment, and as illustrated in FIG. 6, a method includes: applying a first channel estimating algorithm to a resource mapping using known reference resources to obtain initial channel estimates (501); decoding a plurality of control channels to determine which of the plurality of decoded control channels comprise at least one preferred control channel (502); re-encoding the at least one preferred control channel to obtain at least one new reference resource (503); and applying a second channel estimating algorithm to the resource mapping using the known reference resources and the at least one new reference resource to obtain revised channel estimates (504). Note that the decoding (502) is based on the obtained initial channel estimates.

A method as above, further comprising: in response to at least one condition being satisfied, reiterating the decoding, re-encoding and applying the second channel estimating algorithm for at least one additional control channel. A method as in any above, wherein the at least one condition comprises at least one of a cyclic redundancy check or a Viterbi decoding path metric. A method as in any above, further comprising: verifying a quality of the at least one new reference resource such that if the revised channel estimates differ by a certain amount much from the initial channel estimates, the revised channel estimates are discarded. A method as in any above, where the first channel estimation algorithm comprises the second channel estimation algorithm.

A method as in any above, further comprising: performing multiple input/multiple output processing on a control channel to obtain a composite signal, where decoding comprises decoding the composite signal. A method as in any above, further comprising: power scaling the obtained at least one reference resource. A method as in any above, where the control channels comprise shared control channels. A method as in any above, further comprising: receiving an orthogonal frequency division multiplexing transmission from a wireless communication system access node. A method as in any above, wherein the method is implemented by a computer program. A computer-readable medium that stores computer program instructions, the execution of which results in operations comprising (steps of) any one of the above methods.

In other embodiments, the method further comprises: in response to a condition being met, reiterating the decoding, re-encoding and applying the second channel estimating algorithm for at least one additional preferred control channel. In further embodiments, the method further comprises: verifying a quality of the at least one new reference resource such that if the revised channel estimates differ too much from the initial channel estimates, the revised channel estimates are discarded. In other embodiments, the first channel estimating algorithm comprises the second channel estimating algorithm. In further embodiments, the method further comprises: performing MIMO processing on a control channel to obtain a composite signal, wherein decoding comprises decoding the composite signal.

In another non-limiting, exemplary embodiment, a computer-readable medium that stores computer program instructions, the execution of which results in operations that comprise: applying a first channel estimation algorithm to a resource mapping using known reference resources to obtain initial channel estimates; decoding, based on the obtained initial channel estimates, a plurality of control channels to determine which of the plurality of decoded control channels comprise at least one preferred control channel; re-encoding the at least one preferred control channel to obtain at least one new reference resource; and applying a second channel estimation algorithm to the resource mapping using the known reference resources and the at least one new reference resource to obtain revised channel estimates.

A computer-readable medium as above, the operations further comprising: in response to at least one condition being satisfied, reiterating the decoding, re-encoding and applying the second channel estimating algorithm for at least one additional control channel. A computer-readable medium as in any above, wherein the at least one condition comprises at least one of a cyclic redundancy check or a Viterbi decoding path metric. A computer-readable medium as in any above, the operations further comprising: verifying a quality of the at least one new reference resource such that if the revised channel estimates differ by a certain amount much from the initial channel estimates, the revised channel estimates are discarded.

A computer-readable medium as in any above, where the first channel estimation algorithm comprises the second channel estimation algorithm. A computer-readable medium as in any above, the operations further comprising: performing multiple input/multiple output processing on a control channel to obtain a composite signal, where decoding comprises decoding the composite signal. A computer-readable medium as in any above, the operations further comprising power scaling the obtained at least one reference resource. A computer-readable medium as in any above, where the control channels comprise shared control channels. A computer-readable medium as in any above, embodied in a mobile communication apparatus comprising a receiver configurable for receiving an orthogonal frequency division multiplexing transmission from a wireless communication system access node.

In another non-limiting, exemplary embodiment, an apparatus comprising: a channel estimator configurable to apply a first channel estimation algorithm to a resource mapping using known reference resources to obtain initial channel estimates; a decoder configurable to decode, based on the obtained initial channel estimates, a plurality of control channels to determine which of the plurality of decoded control channels comprise at least one preferred control channel; and an encoder configurable to re-encode the at least one preferred control channel to obtain at least one new reference resource, where the channel estimator is further configurable to apply a second channel estimation algorithm to the resource mapping using the known reference resources and the at least one new reference resource to obtain revised channel estimates.

An apparatus as above, further configurable to respond to at least one condition being satisfied to reiterate the decoding, re-encoding and applying the second channel estimation algorithm for at least one additional control channel. An apparatus as in any above, wherein the at least one condition comprises at least one of a cyclic redundancy check or a Viterbi decoding path metric. An apparatus as in any above, further configurable to verify a quality of the at least one new reference resource such that if the revised channel estimates differ by a certain amount much from the initial channel estimates, the revised channel estimates are discarded.

An apparatus as in any above, where the first channel estimation algorithm comprises the second channel estimation algorithm. An apparatus as in any above, further configurable to perform multiple input/multiple output processing on a control channel to obtain a composite signal, and where said decoder decodes the composite signal. An apparatus as in any above, further configurable to power scale the obtained at least one reference resource. An apparatus as in any above, embodied in a mobile communication apparatus comprising a receiver configurable for receiving an orthogonal frequency division multiplexing transmission from a wireless communication system access node, where the control channels comprise shared control channels.

In another non-limiting, exemplary embodiment, an apparatus comprising: means for applying a first channel estimation algorithm to a resource mapping using known reference resources to obtain initial channel estimates; means for decoding, based on the obtained initial channel estimates, a plurality of shared control channels to determine which of the plurality of decoded shared control channels comprise at least one preferred control channel; and means for re-encoding the at least one preferred control channel to obtain at least one new reference resource, where said means for applying is further for applying a second channel estimation algorithm to the resource mapping using the known reference resources and the at least one new reference resource to obtain revised channel estimates.

An apparatus as above, further comprising means for receiving an orthogonal frequency division multiplexing transmission from a wireless communication system access node. An apparatus as in any above, further comprising means for performing multiple input/multiple output processing on a control channel to obtain a composite signal, where said decoding means decodes the composite signal. An apparatus as in any above, wherein the means for applying comprises a channel estimator, the means for decoding comprises a decoder, and the means for re-encoding comprises an encoder. An apparatus as in any above, embodied in a mobile communication apparatus.

An apparatus as above, further configurable to respond to at least one condition being satisfied to reiterate the decoding, re-encoding and applying the second channel estimation algorithm for at least one additional control channel. An apparatus as in any above, wherein the at least one condition comprises at least one of a cyclic redundancy check or a Viterbi decoding path metric. An apparatus as in any above, further configurable to verify a quality of the at least one new reference resource such that if the revised channel estimates differ by a certain amount much from the initial channel estimates, the revised channel estimates are discarded.

An apparatus as in any above, where the first channel estimation algorithm comprises the second channel estimation algorithm. An apparatus as in any above, further configurable to perform multiple input/multiple output processing on a control channel to obtain a composite signal, and where said decoder decodes the composite signal. An apparatus as in any above, further configurable to power scale the obtained at least one reference resource. An apparatus as in any above, where the control channels comprise shared control channels.

In another non-limiting, exemplary embodiment, an electronic device comprises: a data processor configured to apply a first channel estimating algorithm to a resource mapping using known reference resources to obtain initial channel estimates; a decoder configured to decode a plurality of control channels to determine which of the plurality of decoded control channels comprise at least one preferred control channel; and an encoder configured to re-encode the at least one preferred control channel to obtain at least one new reference resource, wherein the data processor is further configured to apply a second channel estimating algorithm to the resource mapping using the known reference resources and the at least one new reference resource to obtain revised channel estimates.

In another non-limiting, exemplary embodiment, an electronic device comprises: first processing means for applying a first channel estimating algorithm to a resource mapping using known reference resources to obtain initial channel estimates; decoding means for decoding a plurality of control channels to determine which of the plurality of decoded control channels comprise at least one preferred control channel; encoding means for re-encoding the at least one preferred control channel to obtain at least one new reference resource; and second processing means for applying a second channel estimating algorithm to the resource mapping using the known reference resources and the at least one new reference resource to obtain revised channel estimates.

In other embodiments, the first processing means comprises a data processor, the decoding means comprises a decoder, the encoding means comprises an encoder, and the second processing means comprises the data processor. In further embodiments, the first processing means comprises the second processing means.

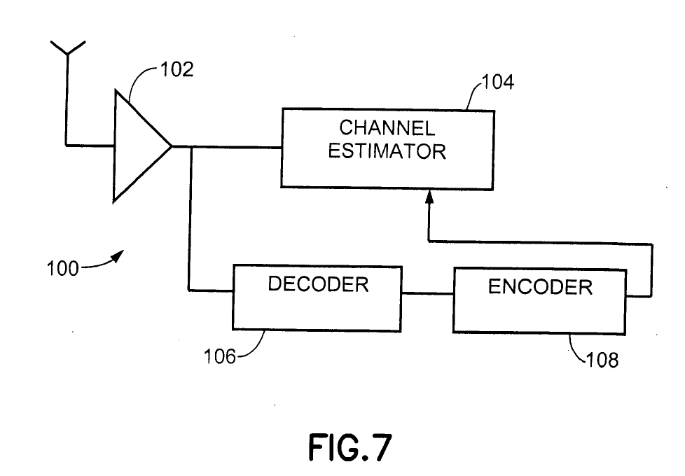

In another non-limiting, exemplary embodiment, and referring to FIG. 7, an exemplary apparatus 100 comprises a radio frequency receiver 102 having an output coupled to a channel estimator 104 configurable to apply a first channel estimation algorithm to a resource mapping using known reference resources to obtain initial channel estimates; a decoder 106 configurable to decode, using the initial channel estimates, a plurality of control channels to determine which of the plurality of decoded control channels comprise at least one preferred control channel; and an encoder 108 configurable to re-encode the at least one preferred control channel to obtain at least one new reference resource, where the channel estimator 104 is further configurable to apply a second channel estimation algorithm to the resource mapping using the known reference resources and the at least one new reference resource to obtain revised channel estimates. The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

While the exemplary embodiments have been described above in the context of the LTE system, it should be appreciated that the exemplary embodiments of this invention are not limited for use with only this one particular type of wireless communication system, and that they may be used to advantage in other wireless communication systems. Furthermore, while described herein with respect to one implementation of an LTE system, it should be appreciated that the exemplary embodiments of this invention are not limited thereto and may be used in conjunction with other implementations of an LTE system, such as FDD and TDD modes, as non-limiting examples.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method, comprising:
applying a first channel estimation algorithm to a resource mapping using known reference resources to obtain initial channel estimates;
decoding, based on the obtained initial channel estimates, a plurality of control channels to determine which of the plurality of decoded control channels comprise at least one preferred control channel;
re-encoding the at least one preferred control channel to obtain at least one new reference resource; and
applying a second channel estimation algorithm to the resource mapping using the known reference resources and the at least one new reference resource to obtain revised channel estimates.

2. The method of claim 1, further comprising: in response to at least one condition being satisfied, reiterating the decoding, re-encoding and applying the second channel estimating algorithm for at least one additional control channel.

3. The method of claim 2, wherein the at least one condition comprises at least one of a cyclic redundancy check or a Viterbi decoding path metric.

4. The method of claim 1, further comprising: verifying a quality of the at least one new reference resource such that if the revised channel estimates differ by a certain amount much from the initial channel estimates, the revised channel estimates are discarded.

5. The method of claim 1, where the first channel estimation algorithm comprises the second channel estimation algorithm.

6. The method of claim 1, further comprising: performing multiple input/multiple output processing on a control channel to obtain a composite signal, where decoding comprises decoding the composite signal.

7. The method of claim 1, further comprising: power scaling the obtained at least one reference resource.

8. The method of claim 1, where the control channels comprise shared control channels.

9. The method of claim 1, further comprising: receiving an orthogonal frequency division multiplexing transmission from a wireless communication system access node.

10. A computer-readable medium that stores computer program instructions, the execution of which results in operations that comprise:
applying a first channel estimation algorithm to a resource mapping using known reference resources to obtain initial channel estimates;
decoding, based on the obtained initial channel estimates, a plurality of control channels to determine which of the plurality of decoded control channels comprise at least one preferred control channel;
re-encoding the at least one preferred control channel to obtain at least one new reference resource; and
applying a second channel estimation algorithm to the resource mapping using the known reference resources and the at least one new reference resource to obtain revised channel estimates.

11. The computer-readable medium of claim 10, the operations further comprising:
in response to at least one condition being satisfied, reiterating the decoding, re-encoding and applying the second channel estimating algorithm for at least one additional control channel.

12. The computer-readable medium of claim 11, wherein the at least one condition comprises at least one of a cyclic redundancy check or a Viterbi decoding path metric.

13. The computer-readable medium of claim 10, the operations further comprising:
verifying a quality of the at least one new reference resource such that if the revised channel estimates differ by a certain amount much from the initial channel estimates, the revised channel estimates are discarded.

14. The computer-readable medium of claim 10, where the first channel estimation algorithm comprises the second channel estimation algorithm.

15. The computer-readable medium of claim 10, the operations further comprising:
performing multiple input/multiple output processing on a control channel to obtain a composite signal, where decoding comprises decoding the composite signal.

16. The computer-readable medium of claim 10, the operations further comprising power scaling the obtained at least one reference resource.

17. The computer-readable medium of claim 10, where the control channels comprise shared control channels.

18. The computer-readable medium of claim 10, embodied in a mobile communication apparatus comprising a receiver configurable for receiving an orthogonal frequency division multiplexing transmission from a wireless communication system access node.

19. An apparatus, comprising:
a channel estimator configurable to apply a first channel estimation algorithm to a resource mapping using known reference resources to obtain initial channel estimates;
a decoder configurable to decode, based on the obtained initial channel estimates, a plurality of control channels to determine which of the plurality of decoded control channels comprise at least one preferred control channel; and
an encoder configurable to re-encode the at least one preferred control channel to obtain at least one new reference resource, where the channel estimator is further configurable to apply a second channel estimation algorithm to the resource mapping using the known reference resources and the at least one new reference resource to obtain revised channel estimates.

20. The apparatus of claim 19, further configurable to respond to at least one condition being satisfied to reiterate the decoding, re-encoding and applying the second channel estimation algorithm for at least one additional control channel.

21. The apparatus of claim 20, wherein the at least one condition comprises at least one of a cyclic redundancy check or a Viterbi decoding path metric.

22. The apparatus of claim 19, further configurable to verify a quality of the at least one new reference resource such that if the revised channel estimates differ by a certain amount much from the initial channel estimates, the revised channel estimates are discarded.

23. The apparatus of claim 19, where the first channel estimation algorithm comprises the second channel estimation algorithm.

24. The apparatus of claim 19, further configurable to perform multiple input/multiple output processing on a control channel to obtain a composite signal, and where said decoder decodes the composite signal.

25. The apparatus of claim 19, further configurable to power scale the obtained at least one reference resource.

26. The apparatus of claim 19, embodied in a mobile communication apparatus comprising a receiver configurable for receiving an orthogonal frequency division multiplexing transmission from a wireless communication system access node, where the control channels comprise shared control channels.

27. An apparatus, comprising:
means for applying a first channel estimation algorithm to a resource mapping using known reference resources to obtain initial channel estimates;
means for decoding, based on the obtained initial channel estimates, a plurality of shared control channels to determine which of the plurality of decoded shared control channels comprise at least one preferred control channel; and
means for re-encoding the at least one preferred control channel to obtain at least one new reference resource,
where said means for applying is further for applying a second channel estimation algorithm to the resource mapping using the known reference resources and the at least one new reference resource to obtain revised channel estimates.

28. The apparatus of claim 27, further comprising means for receiving an orthogonal frequency division multiplexing transmission from a wireless communication system access node.

29. The apparatus of claim 27, further comprising means for performing multiple input/multiple output processing on a control channel to obtain a composite signal, where said decoding means decodes the composite signal.

30. The apparatus of claim 27, wherein the means for applying comprises a channel estimator, the means for decoding comprises a decoder, and the means for re-encoding comprises an encoder.

31. The apparatus of claim 27, embodied in a mobile communication apparatus.
